(19) United States
(12) Patent Application Publication
(10) Pub. No.: US 2012/0196064 A1
(43) Pub. Date: Aug. 2, 2012

(54) TOUGHENED POLYTRIMETHYLENE BENZENEDICARBOXYLATE RESIN COMPOSITION

(75) Inventors: Lin Fang, Shanghai (CN); Hua Jiao, Shanghai (CN); Lei Ying, Shanghai (CN); Linda S. Ankrom, Marietta, OH (US); Edmund Arthur Flexman, Wilmington, DE (US)

(73) Assignee: E.I.DU PONT DE NEMOURS AND COMPANY, Wilmington, DE (US)

(21) Appl. No.: 13/384,653

(22) PCT Filed: Jul. 29, 2010
(86) PCT No.: PCT/US2010/043698

§ 371 Date: Jan. 18, 2012

(30) Foreign Application Priority Data
Jul. 31, 2009 (CN) 200910161182.X

(51) Int. Cl. C08L 67/02; C08K 5/13; C08K 5/36; B32B 1/02; C08K 5/1535; C08K 5/134; C08K 5/101; C08K 5/103; C08K 5/17; C08K 11/00

(52) U.S. Cl. 428/35.7; 525/176; 524/513; 524/236; 524/323; 524/282; 524/80; 524/111; 524/291; 524/315

(57) ABSTRACT

Thermoplastic polyester compositions, comprising: (a) 54-98% by weight of at least one polytrimethylene terephthalate; (b) 1-45% by weight of at least one impact modifier, and the at least one impact modifier is selected from ethylene copolymers having a general formula of E/X/Y, wherein: E is a radical derived from ethylene and accounts for 40-90% by weight of the total weight of the ethylene copolymer; X accounts for 9-55% by weight of the total weight of the ethylene copolymer and is a radical derived from a monomer having the following general formula:

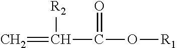

wherein, R₁ is an alkyl containing 2-8 carbon atoms; R₂ is H, CH₃ or C₂H₅; Y is a radical derived from a monomer unit selected from glycidyl methacrylates and glycidyl acrylates and accounts for 0.5-40% by weight of the total weight of the ethylene copolymer; and (c) 0.01-3.0% by weight of a cationic catalyst, and the cation is selected from the group consisting of Mg²⁺, Sn²⁺, and Zn²⁺ and mixtures of these. Also provided are articles made from the thermoplastic polyester compositions.

### TECHNICAL FIELD

The present invention relates to a toughened polytrimethylene terephthalate (PTT) resin composition, which has excellent toughness and surface specular gloss.

### BACKGROUND

Polytrimethylene terephthalate (PTT) resin has excellent surface specular gloss, and is suitable in forming toys, cosmetics packages and sports equipment, etc. However, polytrimethylene terephthalate can be brittle and has low notched impact resistance.

Several methods for toughening polyester resins are known. For example, CN1399663A discloses a thermoplastic polyester, that is, polybutylene terephthalate (PBT) or polyethylene terephthalate (PET), in which an impact strength modifier was added to obtain improved impact resistance and elasticity at low temperatures. There it was discovered that improved impact resistance of thermoplastic polyesters was the result of simultaneously adding three types of modifiers, namely: (a) a shell type copolymer; (b) an ethylene copolymer selected from the group consisting of ethylene-unsaturated epoxide copolymer, ethylene-unsaturated carboxylic acid anhydride copolymer or a mixture thereof; and (c) a copolymer selected from the group consisting of ethylene-alkyl methacrylate copolymer and ethylene-neutralized methacrylic acid copolymer, and mixtures.

It is also provided in CN1399663A that the improvement on impact strength would not cause the flowability to decrease. It in fact causes the flowability to increase.

CN1399663A disclosed an impact strength modifier that would decrease fluidity and might even increase fluidity. CN1399663A aimed to increase impact resistance at low temperatures, that is, below 0° C., while maintaining appropriate melt flow rate. However, this reference is silent as to processability of its polymer composition. Although low temperature impact resistance is important for those polymers used at low temperatures, especially below −40° C., processability is a more important feature for polymers used generally around room temperature, such as those used in making toys and cosmetics packaging materials, especially in considering processing efficiency and cost coupled to an appropriate impact strength.

U.S. Pat. No. 4,753,980 discloses a toughened thermoplastic polyester composition, which comprises a polyester matrix, an ethylene copolymer toughener dispersed throughout the polyester matrix as a discrete phase or discrete particles, and an optional crystallization promoter. The crystallization promoter can be derived from hydrocarbon acids containing 7-54 carbon atoms or organic polymers having at least one carboxyl group, as well as sodium or potassium ion sources that can react with the carboxyl groups of the above-described hydrocarbon acids or organic polymers.

U.S. Pat. No. 4,753,980 discloses a toughened thermoplastic polyester composition, which comprises a polyester matrix, an ethylene copolymer toughener dispersed throughout the polyester matrix as a discrete phase or discrete particles, and an optional crystallization promoter. The crystallization promoter can be derived from hydrocarbon acids containing 7-54 carbon atoms or organic polymers having at least one carboxyl group, as well as sodium or potassium ion sources that can react with the carboxyl groups of the above-described acids or polymers.

Although having good toughness, the polymer therein, when made into articles, imparted a notched impact strength to those articles of only 0.5-0.6 ft-lbs/in. There remains a need for a thermoplastic polymer used at room temperature having improved impact strength and processability.

### SUMMARY

Described herein are thermoplastic polyester compositions having not only good impact strength, but also good processability.

In particular, described herein are thermoplastic polyester compositions, comprising:

(a) 54-98% by weight of at least one polytrimethylene terephthalate;

(b) 1-45% by weight of at least one impact modifier, and the at least one impact modifier is an ethylene copolymer having a general formula of E/X/Y, wherein:

E is a radical derived from ethylene and accounts for 40-90% by weight, preferably accounts for 50-83% by weight, and more preferably accounts for 60-77% by weight of the total weight of the ethylene copolymer;

X accounts for 9-55% by weight, preferably accounts for 15-40% by weight, and more preferably accounts for 20-35% by weight of the total weight of the ethylene copolymer and is a radical derived from a monomer having the following general formula:

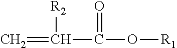

wherein, R₁ is an alkyl containing 2-8 carbon atoms, preferably 4-6 carbon atoms;

R₂ is H, CH₃ or C₂H₅, preferably is H or CH₃, and more preferably is H;

Y is a radical derived from a monomer selected from glycidyl methacrylates and glycidyl acrylates and accounts for 0.5-40% by weight, preferably accounts for 2.0-10% by weight, and more preferably accounts for 3-8% of the total weight of the ethylene copolymer; and

(c) 0.01-3.0% by weight of a cationic catalyst, and the cation is selected from the group consisting of Mg²⁺, Sn²⁺, and Zn²⁺ and mixtures of these,

wherein (a), (b), and (c) comprise the total weight of the thermoplastic polymer composition.

### DETAILED DESCRIPTION OF THE INVENTION

Described herein are thermoplastic polyester compositions with enhanced toughness, which comprise polytrimethylene terephthalates.

As used herein, the term “polytrimethylene terephthalate” refers to (i) trimethylene terephthalate homopolymers consisting essentially of repeating units of trimethylene terephthalate; (ii) trimethylene terephthalate copolymers, in which 65-99.9% by weight, preferably 80-99% by weight, and more preferably 85-95% by weight of repeating units are trimethylene terephthalates; or (iii) blends of trimethylene terephthalate homopolymers or copolymers and other alkylene terephthalate homopolymers or copolymers that are not trimethylene terephthalate homopolymers or copolymers, in which the trimethylene terephthalate homopolymers or copolymers accounts for 65-99.9% by weight, preferably accounts for 80-99% by weight, and more preferably accounts for 85-95% by weight of the total weigh to the blends

The other alkylene terephthalate homopolymers or copolymers as described above refers to C₂₋₈-alkylene terephthalate homopolymers or copolymers that are not trimethylene terephthalate homopolymers or copolymers, preferably C₂₋₆-alkylene terephthalate homopolymers or copolymers that are not trimethylene terephthalate homopolymers or copolymers. Examples of the other alkylene terephthalate homopolymer or copolymers include, without limitation, butylene terephthalate homopolymers or copolymers, ethylene terephthalate homopolymers or copolymers, hexamethylene terephthalate homopolymers or copolymers, and the like.

Examples of the above-described trimethylene terephthalate copolymers include, without limitation, trimethylene terephthalate-butylene terephthalate copolymers, trimethylene terephthalate-ethylene terephthalate copolymers, and mixtures thereof. Examples of blends of trimethylene terephthalate homopolymers or copolymers and other alkylene terephthalate homopolymers or copolymers include, without limitation, blends of trimethylene terephthalate homopolymers or copolymers and butylene terephthalate homopolymers or copolymers, blends of trimethylene terephthalate homopolymers or copolymers and ethylene terephthalate homopolymers or copolymers.

The polytrimethylene terephthalate used in these compositions may be a blend of trimethylene terephthalate homopolymer and butylene terephthalate homopolymer, in which the trimethylene terephthalate homopolymer usually accounts for 65-99% by weight, preferably accounts for 80-98% by weight, and more preferably accounts for 85-95% by weight of the blend.

The polytrimethylene terephthalate suitable for the thermoplastic polyester compositions disclosed herein may have an intrinsic viscosity of 0.9-1.5 dl/g, preferably 0.95-1.1 dl/g, and more preferably 0.98-1.05 dl/g, and a terminal carboxyl group value of 5-80 meq/kg, preferably 8-50 meq/kg, and more preferably 10-40 meq/kg.

Based on the total weight of the thermoplastic polyester composition, the polytrimethylene terephthalate accounts for 54-98% by weight, preferably for 59-96% by weight, and more preferably for 64-94% by weight.

The thermoplastic polyester compositions described herein may further comprise one or more impact modifiers that are selected from ethylene copolymers, such as those described in U.S. Pat. No. 4,753,980, hereby incorporated herein by reference, and have a general formula of E/X/Y, wherein,

E is a radical derived from ethylene and accounts for 40-90% by weight, preferably for 50-83% by weight, and more preferably for 60-77% by weight of the total weight of the ethylene copolymer;

X accounts for 9-55% by weight, preferably accounts for 15-40% by weight, and more preferably accounts for 20-35% by weight of the total weight of the ethylene copolymer and is a radical derived from a monomer having the following general formula;

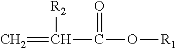

R₁ being an alkyl containing 2-8 carbon atoms, preferably 4-6 carbon atoms;

R₂ being H, CH₃ or C₂H₅, preferably being H or CH₃, and more preferably being H; and

Y is a radical derived from a monomer selected from glycidyl methacrylates and glycidyl acrylates and accounts for 0.5-40% by weight, preferably for 2.0-10% by weight, and more preferably for 3-8% of the total weight of the ethylene copolymer.

The ethylene copolymers used herein as the impact modifiers may be selected from the group consisting of ethylene-butyl acrylate-glycidyl methacrylate (E/BA/GMA) copolymers, ethylene-ethyl acrylate-glycidyl acrylate copolymers, ethylene-hexyl acrylate-glycidyl methacrylate copolymers, and mixtures of two or more thereof. Preferably, the impact modifier is ethylene-butyl acrylate-glycidyl methacrylate copolymer.

In a preferred embodiment, the ethylene copolymers used as the impact modifiers are selected from ethylene-butyl acrylate-glycidyl methacrylate copolymers, ethylene-ethyl acrylate-glycidyl acrylate copolymers, ethylene-hexyl acrylate-glycidyl methacrylate copolymers, and mixtures of two or more thereof. In the above ethylene copolymers, the content of the monomer units derived from glycidyl acrylate accounts for 2-15% by weight, and preferably accounts for 5-12% by weight of the total weight of each of the ethylene copolymer.

The impact modifiers used herein may be purchased from, for example, DuPont USA under that trade names of Elvaloy® PTW (an ethylene-butyl acrylate-5% by weight of glycidyl methacrylate copolymer) or Elvaloy® 4170 (an ethylene-butyl acrylate-9% by weight of glycidyl methacrylate copolymer).

In the thermoplastic polyester compositions disclosed herein, the impact modifier accounts for 1-45% by weight, preferably accounts for 3-40% by weight, and more preferably accounts for 5-35% by weight.

In addition to the impact modifiers, the thermoplastic polyester compositions described herein may optionally further comprise one or more auxiliary impact modifiers selected from maleic anhydride grafted ethylene copolymers and ethylene copolymers having a general formula of E/X (in which monomer units E and monomer units X are as defined above and the weight ratio of the monomer units E and monomer units X is about 1.0-4.0:1, preferably 1.5-3.5:1, and more preferably 2-3:1).

Based on the total weight of the thermoplastic polyester compositions described herein, the optional auxiliary impact modifier may account for 0-25% by weight, preferably account for 0.1-20% by weight, and more preferably account for 0.2-15% by weight.

The thermoplastic polyester compositions described herein may also comprise a cationic catalyst for accelerating extrusion reaction. The inventors have discovered that, when cations are added to a mixture of the above-described polytrimethylene terephthalate and impact modifier(s), the extruded articles obtained therefrom not only have significantly improved toughness, but also have improved processability (e.g., shortened injection molding cycle).

The cationic catalysts described herein are used for accelerating reaction between the functional groups of glycidyl(meth)acrylate and the terminal carboxyl groups of polytrimethylene terephthalate, Moreover, it is also discovered that the cationic catalyst disclosed herein can not only catalyze the reaction between the functional groups, but also can function as a nucleating agent, thus improving injection molding processability of the polymer.

Cations suitable for the thermoplastic polyester composition described herein are selected from Zn²⁺, Mg²⁺, Sn²⁺, and mixtures of these, preferably are selected from Zn²⁺, Sn²⁺, and mixtures of these.

Suitable anion ions that are used as balancing ions for the cations may be any known anions having a number average molecular weight of less than 2500. The anion ions may be selected from carboxylic acid radicals derived from organic carboxylic acids, such as stearic acid radicals, lauric acid radicals, and the like.

Based on the total weight of the thermoplastic polyester compositions, the cationic salt used as the extrusion reaction catalyst is present in the composition at a level of 0.01-3.0% by weight, preferably 0.1-2.5% by weight, more preferably 0.3-2.0% by weight, and most preferably 0.5-1.5% by weight.

The thermoplastic polyester compositions described herein may also comprise other conventional additives, such as plasticizers, UV light stabilizers, flame retardants, antioxidants, processing aids, pigments, dyes, mold releasing agents, etc.

Suitable mold releasing agents can prevent the polymer melt from adhering to hot equipment during injection molding, and therefore facilitating mold releasing at high temperatures. Suitable mold releasing agents can also improve feeding performance, and therefore preventing polymer granules from melting in feeding zones. Suitable mold releasing agents may be any mold releasing agents commonly used in the art, and may be selected from aliphatic esters, such as partially or fully esterified monohydric alcohols and/or polyhydric alcohols.

Suitable antioxidants may be any antioxidants commonly used in the art, and may be selected from aromatic amines, hindered phenols, dithiocarboxylic esters, phosphites, arylbenzofuranones, bisphenol monoacrylates, hindered amines and hydroxylamines, etc.

The thermoplastic polyester compositions described herein are further illustrated with the following examples.

### EXAMPLES

### Notched Impact Strength Test

Charpy impact of notched specimens was tested at 23° C. in accordance with ISO 179-1/1eA with the measurement unit being KJ/m².

### Surface Specular Gloss Test at an Angle of 60°

The surface specular gloss test of specimen sheets was performed at an angle of 60° in accordance with ASTM D2457-03. Specular gloss=luminous flux of the specimen/luminous flux of standard sheet×specular gloss of standard sheet. The standard sheet was defined as 100.0 luminous units.

### Injection Molding Cycle (Cycle Time) Test

Injection molding cycle is calculated as the time required for completing one operation of injection molding. In the Examples, injection molding cycles of ISO 527 stretch specimen strips (Type 1A, 4 mm thick) were compared.

### Example 1

94.9 parts by weight of PTT-1 (a polytrimethylene terephthalate with an intrinsic viscosity of 1.02 dl/g and a terminal carboxyl group value of 9.9 meq/kg, purchased from DuPont USA), 5 parts by weight of E/BA/GMA-1 (Elvaloy® PTW, an ethylene-butyl acrylate-(5% by weight of) glycidyl methacrylate copolymer purchased from DuPont U.S.A.), and 0.1 parts by weight of zinc stearate were added into a twin screw extruder (Toshiba TEM35) and stirred. Then, injection molding was carried out on a Sumitomo 100 ton with a screw diameter of 32 mm and a nozzle diameter of 5 mm. The melt temperature was set at 250° C., and mold temperature at 80° C.

Charpy impact tests of the specimen strips were performed at 23° C. in accordance with ISO 179-1/1eA, and the results are listed in Table 1 below.

### Examples 2-3 and Comparative Example 1

The procedure of Example 1 was substantially repeated except that the ingredients and contents as shown in Table 1 were used. The Charpy impact test results are listed in Table 1.

TABLE 1

| | Example | | | |
|---|---|---|---|---|
| Material | Comparative | | | |
| (% by weight) | Example 1 | Example 1 | Example 2 | Example 3 |
| PTT-1 | 100 | 94.9 | 84.8 | 69.6 |
| E/BA/GMA-1 | | 5 | 15.1 | 30.3 |
| Zinc stearate | | 0.1 | 0.1 | 0.1 |
| Total | 100 | 100 | 100 | 100 |
| Notched impact | 2.2 | 4.2 | 18.3 | 43.6 |
| strength (KJ/m²) | | | | |

These results show that, with the addition of E/BA/GMA and zinc stearate, the Charpy impact resistance of PTT was improved greatly.

### Examples 4-6

The procedure of Example 1 was substantially repeated except that the ingredients and contents as shown in Table 2 were used. The Charpy impact test results were listed in Table 2.

TABLE 2

| | Example | | | |
|---|---|---|---|---|
| Material | Comparative | | | |
| (% by weight) | Example 1 | Example 4 | Example 5 | Example 6 |
| PTT-1 | 100 | 79.7 | 79.7 | 79.7 |
| E/BA/GMA-1 | | 20.2 | | |
| E/BA/GMA-2* | | | 20.2 | |
| E/BA/GMA-3** | | | | 20.2 |
| Zinc stearate | | 0.1 | 0.1 | 0.1 |
| Total | 100 | 100 | 100 | 100 |
| Notched impact | 2.2 | 24.9 | 24.5 | 23.6 |
| strength (KJ/m²) | | | | |

*E/BA/GMA-2: Elvaloy ® 4170, an ethylene-butyl acrylate-(9% by weight of) glycidyl methacrylate copolymer purchased from DuPont, U.S.A.;
**E/BA/GMA-3: an ethylene-butyl acrylate-(12% by weight of) glycidyl methacrylate copolymer.

The above test results also show that, the addition of various E/BA/GMA copolymers and zinc stearate improves the Charpy impact resistance of PTT.

### Examples 7-9

The procedure of Example 1 was substantially repeated except that the ingredients and contents as shown in Table 3 were used. The Charpy impact test results were listed in Table 3. The PBT used in the examples was a polybutylene terephthalate having an intrinsic viscosity of 1.2 dl/g and a terminal carboxyl group value of 35.9 meq/kg.

TABLE 3

| | Example | | | | |
|---|---|---|---|---|---|
| | Compar- | | | | |
| | ative | | | | |
| Material | Exam- | Exam- | Exam- | Exam- | Exam- |
| (% by weight) | ple 1 | ple 2 | ple 7 | ple 8 | ple 9 |
| PTT-1 | 100 | 84.8 | 79.7 | 74.7 | 69.7 |
| PBT | | | 5.1 | 10.1 | 15.1 |
| E/BA/GMA-1 | | 15.1 | 15.1 | 15.1 | 15.1 |
| Zinc stearate | | 0.1 | 0.1 | 0.1 | 0.1 |
| Total | 100 | 100 | 100 | 100 | 100 |
| Notched impact | 2.2 | 18.3 | 12.2 | 24.5 | 30.0 |
| strength | | | | | |
| (KJ/m²) | | | | | |

These test results show that, when blends of PTT and PBT are used instead of PTT, as long as PTT accounts for 65% by weight of the total weight of the composition, the notched impact strength thereof remains high.

### Examples 10-11 and Comparative Examples 2-4

The procedure of Example 1 was substantially repeated except that the ingredients and contents as shown in Table 4 were used. The Charpy impact test results were listed in Table 4.

TABLE 4

| | Example | | | | | | |
|---|---|---|---|---|---|---|---|
| | Comparative | Comparative | Comparative | Comparative | Example | Example | Example |
| Material (% by weight) | Example 1 | Example 2 | Example 3 | Example 4 | 4 | 10 | 11 |
| PTT-1 | 100 | | | | 79.7 | | |
| PTT-2 * | | | | 100 | | 79.7 | |
| PTT-3 ** | | 100 | 99.9 | | | | 79.7 |
| E/BA/GMA-1 | | | | | 20.2 | 20.2 | 20.2 |
| Zinc stearate | | | 0.1 | | 0.1 | 0.1 | 0.1 |
| Total | 100 | 100 | 100 | 100 | 100 | 100 | 100 |
| Notched impact strength | 2.2 | 2.3 | 2.3 | 2.8 | 24.9 | 40.0 | 41.4 |
| (KJ/m²) | | | | | | | |

* PTT-2: a polytrimethylene terephthalate having an intrinsic viscosity of 1.02 dl/g and a terminal carboxyl group value of 12.0 meq/kg;
** PTT-3: a polytrimethylene terephthalate with an intrinsic viscosity of 0.98 dl/g and a terminal carboxyl group value of 13.3 meq/kg.

These test results also show that, the addition of E/BA/GMA and zinc stearate improves the notched impact strength of PTT. In addition, the extent of such improvement on notched impact strength increases as the terminal carboxyl group value of PTT increases. Specifically, when the terminal carboxyl group value of the PTT (PTT-1) was 9.9 meq/kg, the improvement on notched impact resistance was from 2.2 KJ/m² (Comparative Example 1) to 24.9 KJ/m² (Example 4), a 1032% improvement, when the terminal carboxyl group value of the PTT (PTT-2) 12.0 meq/kg, the improvement on notched impact resistance was from 2.8 KJ/m² (Comparative Example 4) to 40.0 KJ/m² (Example 10), a 1329% improvement, and when the terminal carboxyl group value of the PTT (PTT-3) was 13.3, the improvement on notched impact resistance was from 2.3 KJ/m² (Comparative Example 2) to 41.4 KJ/m² (Example 11), a 1687% improvement.

### Examples 12-13, Comparative Examples 5-7

The procedure of Example 1 was substantially repeated except that the ingredients and contents as shown in Table 5 were used. The Charpy impact test results were listed in Table 5.

TABLE 5

| | Example | | | | | | |
|---|---|---|---|---|---|---|---|
| | Comparative | Example | Example | Comparative | Comparative | Comparative | Example |
| Material (% by weight) | Example 1 | 4 | 12 | Example 5 | Example 6 | Example 7 | 13 |
| PTT-1 | 100 | 79.7 | 79.7 | 79.7 | 79.7 | 79.7 | 79.7 |
| E/BA/GMA-1 | | 20.2 | 15.1 | | | | 15.1 |
| ABS ⁽¹⁾ | | | 5.1 | | | | |
| MA-g-EP ⁽²⁾ | | | | | 20.2 | | |
| MA-g-EO ⁽³⁾ | | | | 20.2 | | | |
| MA-g-SEBS ⁽⁴⁾ | | | | | | 20.2 | |
| E/BA ⁽⁵⁾ | | | | | | | 5.1 |
| Zinc stearate | | 0.1 | 0.1 | 0.1 | 0.1 | 0.1 | 0.1 |
| Total | 100 | 100 | 100 | 100 | 100 | 100 | 100 |
| Notched impact strength | 2.2 | 24.9 | 9.9 | 2.8 | 2.8 | 2.9 | 26.6 |
| (KJ/m²) | | | | | | | |
| Specular gloss at an angle of | 100.0 | 96.8 | 99.6 | 83.0 | 50.5 | 70.6 | 95.2 |
| 60° | | | | | | | |

⁽¹⁾ ABS: ABS750, an acrylonitrile-butadiene-styrene rubber purchased from Kumho Petrochemical Co., Ltd., Korea;
⁽²⁾ MA-g-EP: Fusabond ® MF416D, a maleic anhydride grafted ethylene-propylene copolymer purchased from DuPont, U.S.A.;
⁽³⁾ MA-g-EO: Fusabond ® MF493D, a maleic anhydride drafted ethylene-octylene copolymer purchased from DuPont, U.S.A.;
⁽⁴⁾ MA-g-SEBS: Kraton ® FG1921X, a maleic anhydride drafted styrene-ethylene-butylene-styrene with a 1% by weight of maleic anhydride grafting degree, purchased from Shell Chemical, U.S.A.;
⁽⁵⁾ E/BA: Elvaloy ® AC 3427, an ethylene-butyl acrylate copolymer, with 27% by weight of butyl acrylate, purchased from DuPont, U.S.A.

These test results show that, when E/BA was added, in addition to E/BA/GMA and Zinc stearate, the notched impact resistance of PTT was further improved (Example 13 v.s. Example 4).

### Examples 14-15

The procedure of Example 1 was substantially repeated except that the ingredients and contents as shown in Table 6 were used. The Charpy impact test results were listed in Table 6.

TABLE 6

| | Example | | |
|---|---|---|---|
| Material | Comparative | | |
| (% by weight) | Example 4 | Example 10 | Example 14 |
| PTT-2 | 100 | 79.7 | 79.7 |
| E/BA/GMA-1 | | 20.2 | 15.1 |
| MA-g-EO | | | 5.1 |
| Zinc stearate | | 0.1 | 0.1 |
| Total | 100 | 100 | 100 |
| Notched impact | 2.8 | 40.0 | 47.6 |
| strength (KJ/m²) | | | |

Again, these test results show that when an maleic anhydride grafted ethylene copolymer was added in addition to E/BA/GMA and zinc stearate, the notched impact strength of PTT was further improved.

### Examples 17-20 and Comparative Examples 8-11

The procedure of Example 1 was substantially repeated except that the ingredients and contents as shown in Table 7 were used. The Charpy impact test results were listed in Table 7.

TABLE 7

| | Example | | | | | | | | |
|---|---|---|---|---|---|---|---|---|---|
| | Comparative | Comparative | Comparative | Example | Comparative | Example | Example | Comparative | Example |
| Material (parts by weight) | Example 4 | Example 8 | Example 9 | 15 | Example 10 | 16 | 17 | Example 11 | 18 |
| PTT-2 | 100 | 80 | 80 | 80 | 80 | 80 | 80 | 80 | 80 |
| E/BE/GMA | | 20 | 20 | 20 | 20 | 20 | 20 | 20 | 20 |
| Sodium alginate | | | 0.4 | | | | | | |
| Zinc stearate | | | | 0.05 | | | | | |
| Silver acetate | | | | | 0.05 | | | | |
| Zinc acetate dihydrate | | | | | | 0.05 | | | |
| Dibutyltin dilaurate | | | | | | | 0.05 | | |
| Calcium Phytate | | | | | | | | 0.1 | |
| Magnesium stearate | | | | | | | | | 0.1 |
| Notched impact strength | 2.8 | 11.0 | 6.1 | 17.7 | 11.8 | 29.5 | 26.4 | 11.2 | 16.0 |
| (KJ/m²) | | | | | | | | | |
| Injection molding cycle | 65 | 41 | 37 | 36 | 47 | 36 | 36 | 44 | 44 |
| (sec) | | | | | | | | | |

These test results show that the addition of E/BA/GMA improved the impact strength of PTT (see Comparative Examples 8 v.s. Comparative Example 1), while with the addition of a small amount of certain cationic catalyst (such as zinc stearate, zinc acetate dihydrate, dibutyltin dilaurate, or magnesium stearate), the improvement on notched impact strength of PTT was further increased (see Examples 15, 16, 17, and 18 v.s. Comparative Example 8). Moreover, when Zn²⁺ or Sn²⁺ were added as the cationic catalyst, in addition to the improve on notched impact strength, it also shortens the injection molding cycle of PTT and therefore improving its processability.

1. A molded article consisting essentially of a thermoplastic polyester composition, comprising:
(a) 54-98% by weight of at least one polytrimethylene terephthalate;
(b) 1-45% by weight of at least one impact modifier, which is an ethylene copolymer having a general formula of E/X/Y, wherein:
E is a radical derived from ethylene and accounts for 40-90% by weight, preferably 50-83% by weight, and more preferably 60-77% by weight of the total weight of the ethylene copolymer;
X accounts for 9-55% by weight, preferably 15-40% by weight, and more preferably 20-35% by weight of the total weight of the ethylene copolymer and is a radical derived from a monomer having the general formula: 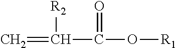
wherein, R₁ is an alkyl group containing 2-8 carbon atoms, preferably 4-6 carbon atoms;
R₂ is H, CH₃ or C₂H₅, preferably is H or CH₃, and more preferably is H;
Y is a radical derived from a monomer selected from glycidyl methacrylates and glycidyl acrylates and accounts for 0.5-40% by weight, preferably 2.0-10% by weight, and more preferably 3-8% of the total weight of the ethylene copolymer; and
(c) 0.01-3.0% by weight of a cationic catalyst, and said cation is selected from the group consisting of Mg²⁺, Sn²⁺, Zn²⁺, and mixtures of these,
wherein (a), (b), (c) comprise the total weight of the thermoplastic polyester composition; and wherein the article:
has a Charpy (notched) impact strength of at least 9 KJ/m² as measured at 23° C. in accordance with ISO 179-1/1eA, and
was molded at an injection molding cycle time of less than 40 seconds.

2. The molded article of claim 1, wherein the polytrimethylene terephthalate is selected from the group consisting of (i) trimethylene terephthalate homopolymers; (ii) trimethylene terephthalate copolymers, in which 65-99.9% by weight, preferably 80-99% by weight, and more preferably 85-95% by weight of repeating units are derived from trimethylene terephthalate, and (iii) blends of trimethylene terephthalate homopolymers or copolymers and other alkylene terephthalate homopolymers or copolymers that are not the trimethylene terephthalate homopolymers or copolymers, in which the trimethylene terephthalate homopolymers or copolymers account for 65-99.9% by weight, preferably 80-99% by weight, and more preferably 85-95% by weight of the total weight of the blends.

3. The molded article of claim 2, wherein the other alkylene terephthalate homopolymers or copolymers are selected from C₂₋₈-alkylene terephthalate homopolymers or copolymers that are not the trimethylene terephthalate homopolymers or copolymers, preferably C₂₋₆-alkylene terephthalate homopolymers or copolymers that are not the trimethylene terephthalate homopolymer homopolymers or copolymers.

4. The molded article of claim 2, wherein the trimethylene terephthalate copolymers are selected from the group consisting of trimethylene terephthalate-butylene terephthalate copolymers, trimethylene terephthalate-ethylene terephthalate copolymers, and mixtures thereof, and wherein the blends of trimethylene terephthalate homopolymers or copolymers and other alkylene terephthalate homopolymers or copolymers are selected from the group consisting of blends of trimethylene terephthalate homopolymers or copolymers and butylene terephthalate homopolymers or copolymers, blends of trimethylene terephthalate homopolymers or copolymers and ethylene terephthalate homopolymers or copolymers, and mixtures thereof.

5. The molded article of claim 1, wherein the at least one polytrimethylene terephthalate has an intrinsic viscosity of 0.9-1.5 dl/g, preferably 0.95-1.1 dl/g, and more preferably 0.98-1.05 dl/g, and a terminal carboxyl group value of 5-80 meq/kg, preferably 8-50 meq/kg, and more preferably 10-40 meq/kg.

6. The molded article of of claim 1, wherein the at least one impact modifier is selected from the group consisting of ethylene-butyl acrylate-glycidyl methacrylate copolymer, ethylene-ethyl acrylate-glycidyl acrylate copolymer, ethylene-hexyl acrylate-glycidyl methacrylate copolymer, and mixtures of these.

7. The molded article of claim 1, wherein the at least one impact modifier is present in the composition at a level of 3-40% by weight, and more preferably 5-35% by weight.

8. The molded article of claim 1, wherein the thermoplastic polyester composition optionally comprises 0-25% by weight of at least one auxiliary impact modifier selected from the group consisting of (i) maleic anhydride grafted ethylene copolymers and (ii) copolymers having a general formula of E/X, the weight ratio of the monomer units E and monomer units X being about 1.0-4.0:1.

9. The molded article of claim 1, wherein the amount of the cationic catalyst, based on the weight of the composition, is 0.1-2.5% by weight, more preferably 0.3-2.0% by weight, and most preferably 0.5-1.5% by weight.

10. The molded article of claim 8, wherein the auxiliary impact modifier having the general formula of E/X is a maleic anhydride grafted ethylene copolymer.

11. The molded article of claim 1, wherein the thermoplastic composition further comprises one or more additives selected from the group consisting of plasticizers, UV light stabilizers, flame retardants, antioxidants, processing aids, pigments, dyes, mold releasing agents, and mixtures thereof.

12. The molded article of claim 11, wherein the mold releasing agent is at least one aliphatic ester selected from the group consisting of partially or fully esterified monohydric alcohols and polyhydric alcohols.

13. The molded article of claim 11, wherein the antioxidant is selected from the group consisting of aromatic amines, hindered phenols, dithiocarboxylic acid esters, phosphites, arylbenzofuranones, bisphenol monoacrylates, hindered amines and hydroxylamines.

14. (canceled)

15. The molded article of claim 1, wherein the article is a toy or container for cosmetics.

16. The molded article of claim 2, wherein the at least one polytrimethylene terephthalate has an intrinsic viscosity of 0.9-1.5 dl/g, preferably 0.95-1.1 dl/g, and more preferably 0.98-1.05 dl/g, and a terminal carboxyl group value of 5-80 meq/kg, preferably 8-50 meq/kg, and more preferably 10-40 meq/kg.

17. The molded article of claim 2, wherein the at least one impact modifier is selected from the group consisting of ethylene-butyl acrylate-glycidyl methacrylate copolymer, ethylene-ethyl acrylate-glycidyl acrylate copolymer, ethylene-hexyl acrylate-glycidyl methacrylate copolymer, and mixtures of these.

18. The molded article of claim 2, wherein the thermoplastic polyester composition optionally comprises 0-25% by weight of at least one auxiliary impact modifier selected from the group consisting of (i) maleic anhydride grafted ethylene copolymers and (ii) copolymers having a general formula of E/X, the weight ratio of the monomer units E and monomer units X being about 1.0-4.0:1.

19. The molded article of claim 2, wherein the amount of the cationic catalyst, based on the weight of the composition, is 0.1-2.5% by weight, more preferably 0.3-2.0% by weight, and most preferably 0.5-1.5% by weight.

20. The molded article of claim 18, wherein the auxiliary impact modifier having the general formula of E/X is a maleic anhydride grafted ethylene copolymer.
